(19) United States
(12) Patent Application Publication
(10) Pub. No.: US 2009/0030718 A1
(43) Pub. Date: Jan. 29, 2009

(54) SYSTEM AND METHOD FOR AUTOMATIC ACQUISITION AND DISTRIBUTION OF INFORMATION IN A REAL ESTATE CONTEXT

(76) Inventor: Rick Robert Bengson, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 12/238,021

(22) Filed: Sep. 25, 2008

Related U.S. Application Data
(60) Provisional application No. 60/976,192, filed on Sep. 28, 2007.

(51) Int. Cl. G06Q 30/00; G06K 19/00

(52) U.S. Cl. 705/1; 340/5.65

(57) ABSTRACT

Certain embodiments of the present invention provide a system for automatically acquiring and distributing information regarding a property showing. The system may include an electronic lock box for securing a property key configured to open a door to a property for sale. The electronic lock box, and the property key therein, is accessible via an electronic key. The electronic key is configured to store showing data regarding the accessing of the electronic lock box. The showing data can be uploaded from the electronic key to a computer and can be transmitted to an electronic database that is accessible to a selling agent. The system also includes a server that generates a feedback request to a buying agent that is assigned to the electronic key that was used to access the lock box. The feedback request requests feedback data from the buying agent regarding the property. The server may store the feedback data received from the buying agent on the database that is accessible to the selling agent. Alternatively, the server may transmit the feedback data to the selling agent.

### RELATED APPLICATIONS

This application claims priority from U.S. Provisional Patent Application Ser. No. 60/976,192, filed Sep. 28, 2007, which is hereby incorporated by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to a system and method for an improved feedback process for real estate professionals. Particularly, the present invention relates to a more efficient system and method for acquiring feedback from a buying agent after a property showing (e.g., when a buyer is shown or views a property that is for sale).

Typically, the market for real estate includes two parties, a buyer and a seller. The buyer may be represented by a buying agent, and the seller may be represented by a selling agent. In order for a potential buyer to view a property for sale, either the seller or the selling agent generally has to grant the potential buyer access to the property. Typically, the selling agent, but not the seller, is present when a property for sale is shown to a buyer.

In order to alleviate the selling agent from repeatedly showing the property, the selling agent may leave a key to the property in a lock box. In an embodiment, a lock box is a hollow box that attaches to the front doorknob or other secure place at the property. A key to open the door to the property for sale (i.e., the property key) may be located inside the lock box. In order to open the lock box and retrieve the property key, one must have a key to the lock box itself (i.e., the lock box key). Typically, the lock box key is an electronic key, such as a magnetic stripe key, key card, electronic fob key, cellular phone key, PDA key or other electronic key. The electronic key may be issued to an agent when that agent is properly registered with the lock box company. The electronic key may contain information about the agent for whom the key is issued. For example, the electronic key may contain the corresponding agent's name, contact information, registration number, and/or a unique identifier.

Most modern lockboxes have electronics to read the information on an electronic key. Typically, the agent may use the electronic key to open the lock box. When the agent uses the electronic key to open the lock box, the lock box writes or records certain information or showing data to the electronic key. The showing data may include the identity of the lock box (e.g., a number corresponding to the lock box), the identity of the property for which the lock box is being used (e.g., by an address or by a reference number), and the date and time the property key was accessed. Accordingly, when an agent accesses or opens the lock box, the lock box electronics “registers” the agent who opens it. Typically, agents are forbidden to let another agent use their electronic keys.

The lock box is generally set with a new address before being installed at a property that is for sale. An agent who accesses the lock box at a particular property can be identified—as well as the date and time he accesses the lock box and the property key locked inside. Generally, the agent that uses his electronic key to access a lock box subsequently transfers the information about accessing the lock box (or showing data) to a database managed by the lock box owner. In an example, showing data may be temporarily stored on the agent's electronic key, uploaded to a computer, and ultimately transferred via the Internet to a lock box database managed by a third party. The selling agent may access the lock box database through a website to view a listing of his properties to monitor showings by various buying agents.

Typically, after the buying agent has shown a property, the selling agent is interested in feedback regarding what the potential buyer thought of the property. For example, information sought may include what the buyer thought of the price of the property, the condition of the property, the specific likes and dislikes of the property, etc. One technique to solicit this feedback is to call the buying agent. A problem with calling the buying agent is that it may be difficult to call the buying agent at a time when the buying agent is available to talk. Another problem with calling the buying agent may be that buying agent does not respond to the requests for information. The difficulty with obtaining feedback regarding the thoughts of a potential buyer may cause delays in selling the property and difficulty in setting an appropriate price for the property.

A real estate feedback system has been developed to automate the request for feedback from a buying agent regarding a property he has shown to a potential buyer. The real estate feedback system facilitates the exchange of information between the seller and the buyer or their agents. One embodiment of the real estate feedback system is provided by HomeFeedback, Inc. The HomeFeedback system is a feedback request service that automates soliciting the buying agent for feedback. Among other features, the HomeFeedback system allows the selling agent to send a set of questions via e-mail to buying agents that have shown properties that the selling agent has listed for sale.

In general, the selling agent manually enters information about a showing into the HomeFeedback system, typically via an Internet website (i.e., www.homefeedback.com). The information may include the name of the buying agent, contact information of the buying agent, and information about the property that was shown. The HomeFeedback system may generate an email message requesting feedback data regarding the property for sale on behalf of the selling agent or seller. The email request may contain a number of questions regarding what the buyer thought of the property. When the buying agent responds, his answers are typically sent to the seller of the property as well as to the selling agent.

The selling agent may utilize the lock box and the HomeFeedback system to make his work more efficient. For example, the selling agent may utilize the information obtained from a lock box, such as the identity of the buying agent, the location of the property, and the time and date of the showing, from the lock box database. The seller may input that information into the HomeFeedback system. The HomeFeedback system may then automatically generate email requests to the buying agent soliciting feedback on the property.

A problem that exists with using both the lock box and HomeFeedback system together is that, currently, the selling agent must manually input the information obtained from the lock box into the HomeFeedback system. The manual entry of this information may be tedious and time consuming work for the selling agent.

Therefore, a system and method is needed that may allow the acquisition of information gathered from a lock box to be used for automatically soliciting feedback from the showing agent.

### BRIEF DESCRIPTION OF THE DRAWINGS

FIG. 1 illustrates an example of a system that may be used in accordance with an embodiment of the present invention.

FIG. 2 illustrates an example of a system that may be used in accordance with an embodiment of the present invention.

FIG. 3 illustrates an example of a method that may be used in accordance with an embodiment of the present invention.

FIG. 4 illustrates an example of a method that may be used in accordance with an embodiment of the present invention.

FIG. 5 illustrates an example of a system that may be used in accordance with an embodiment of the present invention.

### DETAILED DESCRIPTION OF THE INVENTION

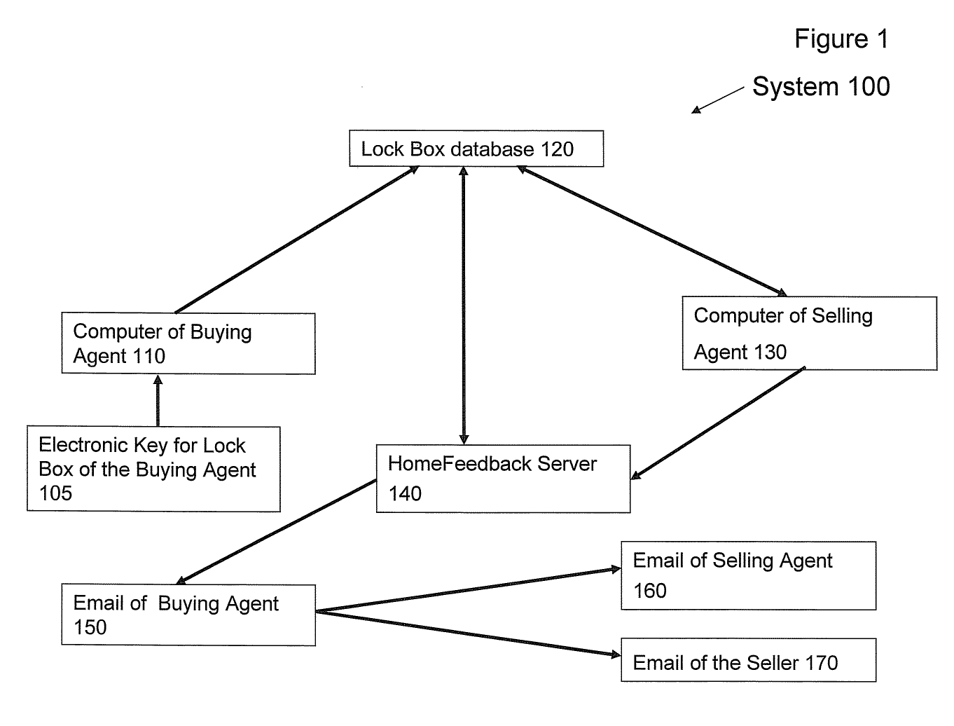

FIG. 1 illustrates an example of a system 100 that may be used in accordance with an embodiment of the present invention. In an embodiment, the system 100 includes the use of the HomeFeedback server 140. The HomeFeedback server 140 is part of a real estate feedback system and method that facilitates the solicitation and exchange of information between the seller and the buyer. For example, the system 100 may include a number of processors, computers, servers, and separate computers being placed with the seller, the selling agents, and the buying agents. The HomeFeedback server 140 may be a single server or multiple servers. The HomeFeedback server 140 generally registers a selling agent and one or more properties listed for sale by the selling agent through a website. Registration generally includes the identification of the selling agent and the property being sold. Once registered, any buying agent that shows the subject property may be identified to the HomeFeedback system, and an inquiry regarding the showing may be sent to the buying agent. The response to the inquiry sent by the buying agent is generally posted as part of a webpage, or generated as an email message and sent to the selling agent and, in an embodiment, the seller.

In operation, users of the HomeFeedback system login to HomeFeedback server 140 through the HomeFeedback website (i.e., www.homefeedback.com). A user that has logged in may access information personal to that user. If the user is acting as a selling agent, the user may customize the feedback questions for a particular property that he has listed for sale. For example the selling agent may request information or feedback data regarding price, condition of the property, or more specific information regarding each room of the property. The selling agent may include multiple pictures of the property and links for virtual tours of the property. The feedback requests may also include an incentive for the buying agent to respond to the request. The incentive may include a monetary incentive or rewards incentive.

The buying agent may respond to the feedback request. The response may take the form of an email message that is sent back to the selling agent, the seller, and the HomeFeedback system. If the buying agent does not respond within a set period of time, the HomeFeedback server 140 may send a follow-up email message requesting feedback. After a preset number of attempts without a response from the buying agent, an email is sent to the seller explaining that the selling agent did not fill out the feedback request form.

In an embodiment, the response (containing requested feedback data) by the buying agent may be sent by to the HomeFeedback server 140. The HomeFeedback server 140 may then forward the response to the selling agent and the seller. In another embodiment, the response may be sent to the HomeFeedback server 140, and also sent to the selling agent and the seller. The HomeFeedback Server 140 may generate feedback statistic reports that can be viewed by users of the HomeFeedback system. The feedback statistic reports can generally be viewed by the selling agent and the seller. The seller may login to view feedback statistics on the feedback data obtained for his property. The HomeFeedback server 140 may also generate email messages containing the feedback reports at predetermined intervals, for example daily, weekly, or monthly and email the reports to the seller and/or selling agent.

The HomeFeedback system may also allow a user, such as a selling agent or buying agent, to post comments to the HomeFeedback website that are time and date stamped. The comments may be accessed by the seller through the website. The HomeFeedback system may store the contact information for the buying agents that have shown the property. Upon request, the HomeFeedback system may generate an email message to each of the buying agents that have shown the property. The HomeFeedback system may also maintain a listing of all agents that are registered with the HomeFeedback system and may utilize the listing to generate the feedback request messages.

The HomeFeedback system may also utilize a calendar feature. The calendar may maintain a schedule of showings for a property. A feedback request message may be scheduled to be sent a set period of time after a showing is scheduled. For example, a feedback request message may be scheduled for one hour after a showing is scheduled. The calendar feature may also send the seller and the buying agent a reminder of the appointment for the showing.

In an embodiment, the system 100 includes a lock box. An example of a lock box that may be used with the system 100 are the lock boxes sold by Sentrilock, LLC., 2710 East Kemper Road, Cincinnati, Ohio 45241 or the lock boxes sold by GE Security, Inc. 8985 Town Center Parkway Bradenton, Fla., 34202-5129. For example, when using the lock box provided by Sentrilock, a buying agent carries a credit card-sized SentriCard® card. The buying agent inserts his personal SentriCard® card as an electronic key and inserts into the lockbox. The buying agent enters his PIN (Personal Identification Number), presses the “Enter” button, and removes his SentriCard® card. After removing the card, the top mounted key compartment's door opens and allows the buying agent access to the property key. The buying agent generally updates his SentriCard® card after a certain period of time. By updating the card, the information or showing data contained on the card may be transmitted to a lock box database existing on a website or server.

In an embodiment, the system 100 includes the electronic key for the lock box 105. The electronic key 105 is the electronic key that the buying agent may use to access the lock box. The electronic key 105 may be a magnetic stripe key, a key card, an electronic fob key, a cellular phone or personal digital assistant (PDA) capable of communicating with the lock box, a global positioning system (GPS) unit capable of communicating with the lock box, or other type of electronic key. The electronic key 105 may have information or showing data stored on it sufficient to determine, for example, the lock box accessed, the identity and contact information of the buying agent, and the date and time of the accessing of the lock box and the property key therein. The buying agent may upload or transfer this information to his computer 110 or other communication device, such as a personal digital assistant or cellular phone. The transfer of this information may occur by electronically transferring the information on the electronic key to the computer, or other device, of the buying agent 110. Simultaneously or thereafter, the information may be transferred to the lock box database 120. The transfer of this information may also occur directly from the electronic key to the lock box database 120. For example, if the electronic key has a computer (such as an electronic key equipped as part of a cellular phone, PDA, or GPS unit), the computer may transfer the information to the lock box through a cellular or wireless broadband network. In fact, in such an embodiment, the transfer can occur immediately and automatically after accessing the lock box.

The lock box database 120 may be a database that is maintained by a third party, such as the manufacturer of the lock box. The lock box database 120 may also be maintained by an association, such as the Multiple Listing Service. In an embodiment, users that are authorized to access the lock boxes may also be authorized to access the lock box database 120. In an embodiment, users may access the lock box database 120 through an Internet website.

In an embodiment, a software application running on the computer of the selling agent 130 may periodically access the lock box database 120 and download or transfer information to the computer 130. Alternatively, a software application running on the HomeFeedback server 140 server may periodically access the lock box database 120 and transfer information to the HomeFeedback server 140 server. For example, the software application may query the lock box database 120 to determine whether any new information for a particular lock box having a unique identifier has occurred within the last 24 hours. If new information has been transferred for that particular lock box, the lock box database 120 may communicate with the software application on the seller's computer 120 that new information has been transferred. The software application 130 may request a transfer of the new information from the lock box data base 120. The information may include the identity and contact information of the buying agent, the identity or location (address) of the property, and the time and date of the visit to the property (i.e., the time and date of the accessing of the lock box). In an embodiment, the information may be transferred over the Internet.

Once the application of the computer of the selling agent 130, or the application running on the HomeFeedback server 140, obtains the new information from the lock box database 120, the application 130 may populate that information into the HomeFeedback server 140 as part of a selling agent database. In an embodiment, the application 130 transfers the new information into the HomeFeedback server 140 over the Internet. The new information is populated into the HomeFeedback server 140 in the appropriate categories. The HomeFeedback server 140 then generates feedback requests (e.g., via email messages or website links) to the buying agent. The feedback request may contain questions designed to solicit feedback about the property. In an embodiment, the HomeFeedback server 140 automatically sends the feedback request to the buying agent without intervention from the selling agent.

In an embodiment, the software application accesses the lock box database 120 through the lock box website that is specified for the provider of the lock box. In an embodiment, the software application may utilize the Adobe® AIR™ from Adobe Systems Incorporated, 345 Park Avenue San Jose, Calif. 95110-2704.

The software application may gather information from various websites and databases and send the information to the HomeFeedback web application and/or database. An example of an application that utilizes the Adobe® AIR™ is the Scout application. The Scout application is an example application that provides the ability to inspect the HTML of a webpage. The Scout application is available from Adobe Systems.

In an embodiment, the software application may be downloaded from the HomeFeedback server 140. In an embodiment, the software application is downloaded as an AIR™ application to a user's computer. An install wizard and configuration wizard may run upon being downloaded. As part of the configuration wizard, the user generally selects the company the user has for lockbox services. The user generally enters his username and password for the lockbox website. Also as part of the configuration wizard, the user selects which multiple listing service the user has for multiple listing services. The user generally enters his username and password for the multiple listing service website. Also as part of the configuration wizard, the user may select whether he wants the software application to periodically poll the lock box website and the multiple listing service website and with what frequency. For example, the user may enter information that the software application should poll the lock box website and the multiple listing service website once per day at 12:00 AM.

The software application may log into the website using a username/password for the lock box website. The software application may access the lock box website via HTTP requests. The software application may access the lock box database 120 through the lock box website by providing the identifier for the lock box. Information regarding new showings for the lock box may be obtained from the lock box database 120. The software application may obtain the information regarding new showings for the lock box and transmit that information to the user's computer or the HomeFeedback server 140. The software application may transmit the information to the HomeFeedback server 140 via a HTTP post or Web Service. The software application may also synchronize the new showing information with the current showing information for a particular lock box as a check against duplicate property showings.

The feedback requests from the HomeFeedback server 140 queries the buying agent for feedback data 150. In an embodiment, the buying agent's response (containing the feedback data) is sent to the selling agent 160 and the seller 170. In an embodiment, the buying agent's response (containing the feedback data) is sent to the selling agent 160, the seller 170, and the selling agent database on the Homefeedback server 140. The response that is sent to the HomeFeedback server 140 may be used to compile statistical information. For example, the response that is sent to the HomeFeedback system may be used to compile statistical information regarding the feedback data received from multiple buying agents that have shown the property. Such statistical information may include, for example, that 8 out 10 people thought the price of was too high. As another example, 5 out of 10 people thought the bedrooms were too small. The statistical information may allow a seller to better identify the proper price point for a property and identify the strength's and weaknesses of that property.

In an embodiment, a device other than a lock box may be used to obtain information regarding access to the property. For example, the door allowing access to a property may have a lock that utilizes an electronic locking mechanism that is controlled through the use of an electronic key or code pad. It is contemplated that the electronic locking mechanism or electronic key may record information or showing data regarding access to the property. In an embodiment, the electronic locking mechanism may be programmed to allow access to buying agents. The electronic locking mechanism or electronic key may record access by a buying agent. In an embodiment, the electronic locking mechanism may write or record showing data to the electronic key the buying agent uses to access the electronic locking mechanism. Even though an embodiment of the invention may employ a device other than a lock box for gaining access to a property for sale, a lock box database may still be employed to receive the showing data. Thus, the database may still be termed a “lock box database” despite the absence of an actual lock box.

For example, a door of a property may have an electronic card-reading device that acts as an electronic locking mechanism. A key card may be inserted into the electronic card-reading device. If the key card contains a correct access code, the electronic card-reading device may instruct the electronic locking mechanism to open the lock of the door. In an embodiment, the electronic card-reading device may be programmed to grant access to buying agents having a key card with a specific code. The electronic card-reading device may write showing data to the key card. The showing data can subsequently be uploaded or transferred from the key card to a lock box database.

It is also contemplated that the electronic locking mechanism installed in a door may be connected to a home computer network. The home computer network may be connected to a computer system. The computer system may be connected to the Internet. In an embodiment, the electronic locking mechanism may record the showing data and transmit it over the home network to the computer system. The showing data transmitted to the computer system may include, for example, the location, time, date, and contact information of the agent that accessed the property. The computer system may then utilize this information to solicit feedback.

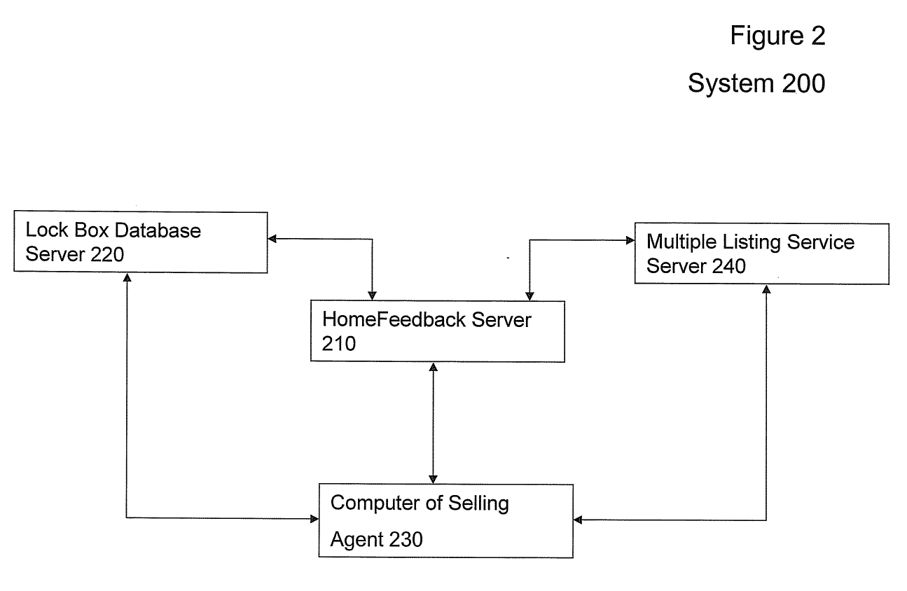

FIG. 2 illustrates an example of a system 200 that may be used in accordance with an embodiment of the present invention. As mentioned with regard to the system 100, a software application for acquiring input for the HomeFeedback system may reside on a computer of the selling agent. In an embodiment, the selling agent may transfer the software application to his computer 230 from the HomeFeedback server 210. In another embodiment, the software application may reside on and be executed on the HomeFeedback server 210. In an embodiment, the software application may acquire information from the lock box database server 220. The information that is acquired from the lock box database server 220 may be information that is gathered from a lock box at a property and information about the buying agent. In an embodiment, the software application may also acquire information from the Multiple Listing Service database 240. In an embodiment, the software application may access the Multiple Listing Service database 240 through the Internet using the user identity and password. For example, a selling agent may input information into the Multiple Listing Service database. Rather than having to re-input that same information into the HomeFeedback system, the software application running on the computer of the selling agent 230 may acquire the information from the Multiple Listing Service database 240.

In an embodiment, the software application running on the computer of the selling agent 230 periodically queries the lock box database 220 for new information. The query may include a request for new information regarding a unique lock box identifier. The query may contain more than one unique lock box identifier. The lock box database 220 may respond back to the software application 230 to identify whether new information exists. If new information does exist, the information may be transferred to the software application on the selling agent computer 230. This information may then be automatically transferred to the HomeFeedback system 210. In an embodiment, the information is transferred to the HomeFeedback system server 210 over the Internet. The HomeFeedback system server 210 then utilizes this information to formulate an email message to the buying agent requesting feedback data regarding the property.

In an embodiment, the software application running on the computer of the selling agent 230 periodically queries the Multiple Listing Service database 240. The software application 230 may query the Multiple Listing Service database 240 for new entries made by the selling agent. For example, a selling agent enters a new listing in the Multiple Listing Service database 240. As part of this listing information, the selling agent includes his name and/or identification number. The software application 230 queries the Multiple Listing Service database 240 for new entries made by the selling agent. If a new entry is found, the software application 230 transfers the new information to the selling agent's computer. The software application 230 then transfers the new information to the HomeFeedback system 210. The information is populated in the HomeFeedback system 210. In such a manner, the selling agent enters a new listing into the Multiple Listing Service database 240, and the new listing is automatically entered into the HomeFeedback system 210.

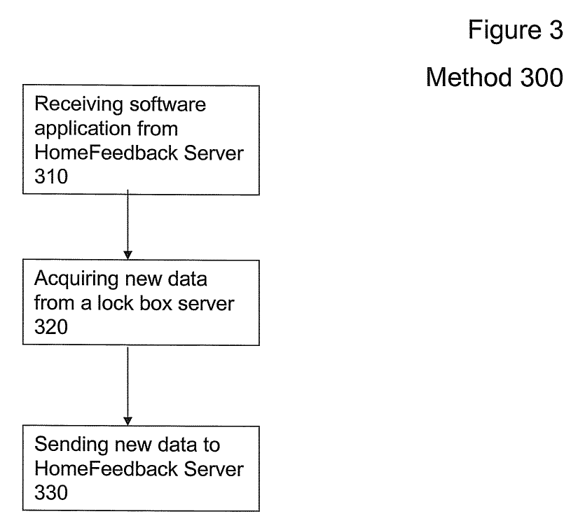

FIG. 3 illustrates an example of a method 300 that may be used in accordance with an embodiment of the present invention. At step 310, the software application designed to run on a user's computer may be received from the HomeFeedback system. In an embodiment, a user may transfer the software application to his personal computer from the HomeFeedback website. At step 320, the software application may acquire new data from the lock box server. The new information may include information regarding whether a buying agent has accessed any of the lock boxes of the selling agent since the last query. For example, the software application may query the lock box server to determine whether any of the lock boxes of the selling agent have been utilized in the past 24 hours. If so, the software application may acquire information regarding the use of the lock box. The information may include the contact information of the buying agent who activated the lock box, the time and place of the activation, and the property associated with the lock box.

In an embodiment, the software application accesses the lock box server through the lock box website that is specified for the provider of the lock box. The software application may log into the website using a username/password for the lock box website. The software application may access the lock box server through the lock box website by providing the identifier for the lock box. Information or showing data regarding new property showings for the lock box may be obtained from a lock box database on the lock box server. The software application may obtain this new information and transmit it to the user's computer or a selling agent database on the HomeFeedback server. The software application may also synchronize the new information with the pre-existing information for a particular lock box as a check against duplicate property showings.

At step 330, the software application may send the information acquired at step 320 to the HomeFeedback server. The information automatically populates the categories of the selling agent database on the HomeFeedback server. The HomeFeedback server may then send feedback requests to the buying agent.

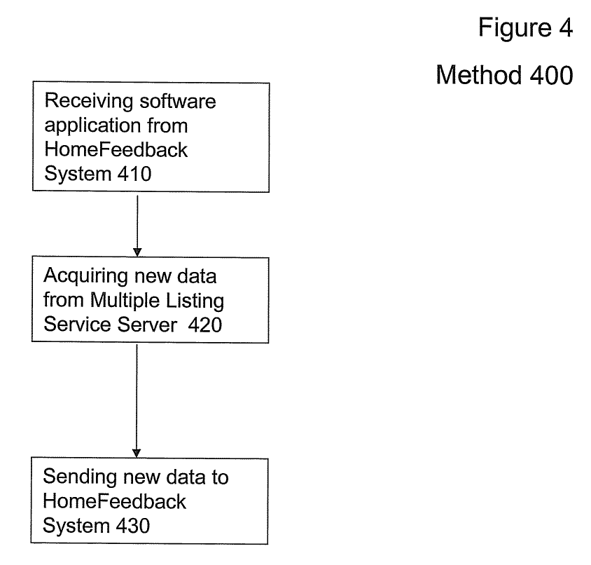

FIG. 4 illustrates an example of a method 400 that may be used in accordance with an embodiment of the present invention. At step 410, the software application designed to run on a user's computer may be received from the HomeFeedback system. In an embodiment, a user may transfer the software application to his personal computer from the HomeFeedback website. At step 420, the software application may acquire new data from the Multiple Listing Service database. The new data may include information regarding whether the agent has input any new information into the Multiple Listing Service database. For example, the software application may query the Multiple Listing Service database to determine whether the agent has input any new listings in the past 24 hours. If so, the software application may acquire information regarding the new listings. The information may include information regarding the listing, contact information of the selling agent, and other information that may be included in the listing.

In an embodiment, the software application accesses the Multiple Listing Service database through the Multiple Listing Service website. An example of the Multiple Listing Service Website is www.sandicor.com. The software application may access the Multiple Listing Service website via HTTP requests. The software application may log into the website using a username/password for the Multiple Listing Service website. The software application may access the Multiple Listing Service database through the Multiple Listing Service website by providing the name of the selling agent. Information regarding new property listings for the selling agent may be obtained from the Multiple Listing Service database. The software application may obtain the information regarding new listings and transmit that information to the user's computer or the HomeFeedback server. The software application may also synchronize the new listing information with the current listing information as a check against duplicate listings.

At step 430, the software application may send the information acquired at step 420 to the HomeFeedback system. The information automatically populates the categories of the HomeFeedback system. In such a manner, the selling agent does not need to make an entry for a new listing in both the Multiple Listing Service database as well as the HomeFeedback system.

In an embodiment of the systems and methods described above, a buying agent may visit a property and utilize the lock box to obtain entry. After showing the property, the buying agent may transfer the electronic information in his electronic lock box key to his personal computer or other communication device, such as a personal digital assistant or cellular phone. The information in his electronic key may be transferred to a lock box database through, for example, a cellular or broadband network.

The selling agent may have transferred a software application from the HomeFeedback system to reside on his personal computer. The software application periodically queries the lock box database for new information or showing data regarding the properties the selling agent currently has listed. If new information exists, the new information is transferred to the computer of the selling agent. In the example being discussed here, the new information that the buying agent transferred to the lock box database would be identified by the software application on the computer of the selling agent.

Once the new information or showing data is acquired, it is transferred to the HomeFeedback system and stored in the selling agent database. The new information populates the fields of the HomeFeedback system, including the email address of the buying agent, the property for which feedback is being requested, and the time and date of the showing. The Homefeedback system then sends the buying agent feedback request, via, for example, an email message or website link. A response from the buying agent may be directed to the selling agent, the seller, and/or the selling agent database.

The systems and methods described above may be carried out as part of a computer-readable storage medium including a set of instructions for a computer. The set of instructions may include a first acquisition routine for acquiring information from a lock box server. The first acquisition routine may periodically query the lock box server. The query may include a request for the latest modification of the file for a particular lock box. If the latest modification is less than a predetermined threshold value of time, for example 24 hours, then the first acquisition routine requests a transfer of the new information from the lock box database. The set of instructions may also include a first transfer routine. The first transfer routine transfers the information acquired from the lock box database to the HomeFeedback system.

The set of instructions may also include a second acquisition routine for acquiring information from a Multiple Listing Service server. The second acquisition routine may periodically query the Multiple Listing Service server. The query may include a request for the latest update generated by a particular agent. If a new entry by an agent exists, the second acquisition routine requests a transfer of the new information from the Multiple Listing Service database. The set of instructions may also include a second transfer routine. The second transfer routine transfers the information acquired from the Multiple Listing Service database to the HomeFeedback system.

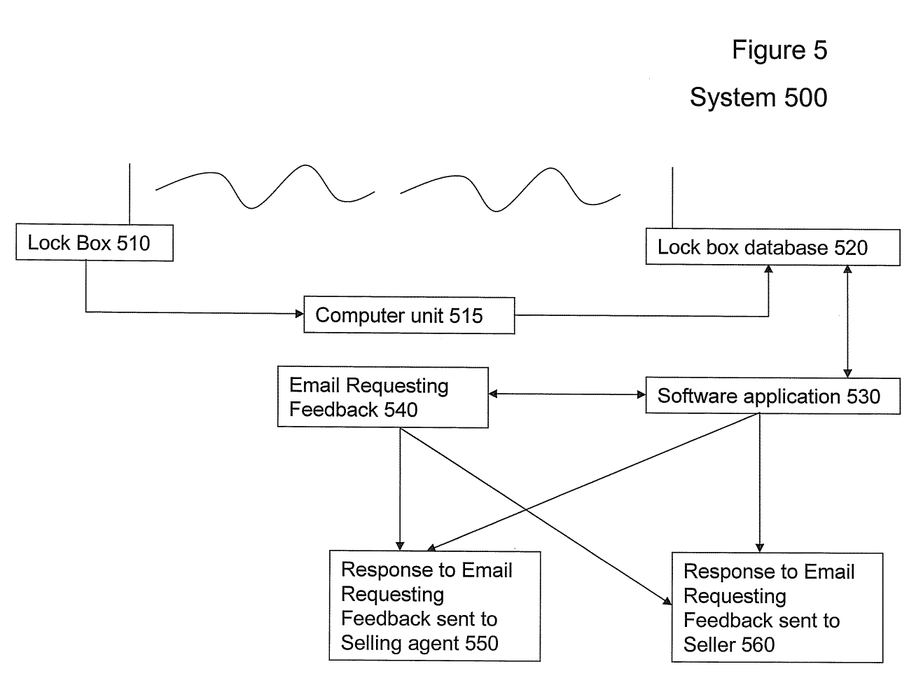

FIG. 5 illustrates an example of an integrated generalized system 500 that may be used in accordance with an embodiment of the present invention. In an embodiment, the system 500 includes a lock box 510. The lock box 510 may be of the type to hold the key to a property. The lock box 510 may generally be accessed by using an electronic key.

After the lock box 510 is accessed, the lock box 510 may communicate with the lock box database 520. In an embodiment the lock box 510 may communicate directly with the lock box database 520. For example, when a user accesses the lock box 510, the lock box may record the showing data and communicate it to the lock box database 520 over a wired or wireless connection or some combination thereof, including, for example, over the Internet.

In another embodiment, the lock box 510 indirectly communicates with the lock box database 520. In an embodiment, the electronic key used to access the lock box may record the showing data. The electronic key may transfer the showing data to the lock box database 520 through a computer unit 515. For example, the showing data may be transferred to the lock box database 520 using a personal computer, cellular phone, personal digital assistant, or other appropriately equipped device.

The lock box database 520 may execute computer software 530 to send a feedback request to the buying agent requesting feedback regarding the property. In an embodiment, the computer software 530 may be executed as part of the lock box database 520. In an embodiment, the computer software 530 may be executed separate from the lockbox database 520. For example, the computer software 530 may reside/execute on a third party server or third party computer.

In an embodiment, the software application 530 generates an email message to the buying agent requesting feedback regarding the showing. The email message may identify the property, the time and date of the showing, and the selling agent. The email message may request information regarding price, property condition, amenities, or any other information from which the seller or selling agent would like to question the buying agent. A response (e.g., via reply email) from the buying agent may typically be sent back to the software application 530. The software application 530 may then forward the response to the selling agent 550 and the seller 560. In an embodiment, the response may be sent to the seller' agent 550 and the seller 560. In this embodiment, the response is not sent back to the software application 530. In another embodiment, the response may be sent to the selling agent 550, the seller 560, and the software application 530. In this embodiment, the software application 530 may use the information or feedback data received in the response to create a statistical analysis of the property. The statistical analysis may include, for example, information regarding what people thought of the price, condition, or layout of the property. For example, the response sent to the software application 530 may be used to compile statistical information regarding the feedback data that buying agents have provided about the property. Such feedback data may include, for example, that 8 out 10 people thought the price of was too high, or that 5 out of 10 people thought the bedrooms were too small. The statistical information may allow a selling agent or seller to better identify the proper a price point for a property and identify the strength's and weaknesses of that property.

While the use of electronic keys has been employed in certain embodiments of the present invention, any device or key capable of engaging a lock box or locking mechanism via an electromagnetic signal (by wire or wirelessly) can be used in certain embodiments of the present invention. For example, cellular phones, PDAs, GPS units, or other portable electronic devices may be equipped with infrared, optical, or electronic communication ports to communicate with lock boxes that are similarly configured.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A system for automatically acquiring and distributing information regarding a property showing, the system comprising:
a lock box for locking a property key therein, said property key configured to open a door to a property for sale;
an electronic key for accessing said lock box and retrieving said property key, said electronic key configured to automatically store showing data regarding said accessing of said lock box;
a computer for transmitting said showing data from said electronic key to a lock box database; and
a server for automatically retrieving said showing data from said lock box database and for transmitting a feedback request to a buying agent assigned to said electronic key, said feedback request requesting feedback data regarding said property for sale.

2. The system of claim 1, wherein said showing data includes one of the group consisting of the identity of said lock box, the identity of said property, the date of said accessing of said lock box, the time of said accessing of said lock box, the identity of a buying agent corresponding to said electronic key, and contact information regarding said buying agent.

3. The system of claim 1, wherein said lock box database is accessible by a selling agent via a software program configured to automatically access said lock box database.

4. The system of claim 1, wherein said feedback request is transmitted via email.

5. The system of claim 1, wherein said server transmits said feedback data to one of the group consisting of a selling agent of said property for sale, a seller of said property for sale, and a selling agent database.

6. The system of claim 5, wherein said feedback data is transmitted via email.

7. The system of claim 5, wherein said showing data includes one of the group consisting of the date of said accessing of said lock box, the time of said accessing of said lock box, the identity of a buying agent assigned to said electronic key, and contact information regarding said buying agent.

8. The system of claim 1, wherein said server automatically updates a selling agent database with said showing data retrieved from said lock box database.

9. The system of claim 1, wherein said lock box database is also a selling agent database.

10. A method for automatically acquiring and distributing information regarding a property showing, the method comprising:
using an electronic key for accessing a property for sale;
automatically storing showing data regarding said accessing of said property for sale on said electronic key;
transferring showing data from said electronic key to a lock box database; and
automatically retrieving said showing data from said lock box database and transmitting said showing data to one of the group consisting of a selling agent of said property for sale, a seller of said property for sale, and a selling agent database.

11. The method of claim 10, further comprising:
generating a feedback request to a buying agent assigned to said electronic key, said feedback request requesting feedback data regarding said property for sale from said buying agent.

12. The method of claim 11, wherein said feedback request is transmitted via email.

13. The method of claim 10, wherein said electronic key consists of a cellular phone, PDA, or GPS unit, and wherein said transferring step occurs automatically soon after said using step.

14. The method of claim 10, wherein said lock box database and said selling agent database are the same database.

15. A computer-readable medium including a set of instructions for execution on a computer that is connected to a network, the set of instructions comprising:
an accessing routine capable of automatically accessing a lock box database and retrieving showing data stored in said lock box database; and
an updating routine capable of updating a selling agent database with said showing data retrieved from said lock box database.

16. A computer-readable medium including a set of instructions for execution on a computer that is connected to a network, the set of instructions of claim 15, further comprising:
a feedback requesting routine capable of sending a feedback request to a buying agent regarding a property for sale, said buying agent and said property for sale being identifiable from said showing data.

17. A system for automatically acquiring and distributing information regarding a property showing, the system comprising:
an electronic key for accessing a property for sale, said electronic key configured to store showing data regarding said accessing of said property;
a computer for transmitting said showing data from said electronic key to a lock box database; and
a server for automatically retrieving said showing data from said lock box database and updating a selling agent database with said showing data.

18. The system of claim 17, wherein said server transmits a feedback request to a buying agent assigned to said electronic key, said feedback request requesting feedback data regarding said property for sale.

19. The system of claim 18, wherein said server transmits said feedback data to one of to one of the group consisting of a selling agent of said property for sale, a seller of said property for sale, and said selling agent database.

20. The system of claim 17, wherein said showing data includes one of the group consisting of the identity of said property, the date of said accessing of said property, the time of said accessing of said property, the identity of a buying agent corresponding to said electronic key, and contact information regarding said buying agent.

21. The system of claim 17, wherein said lock box database and said selling agent database are the same database.
